(19) United States
(12) Patent Application Publication
(10) Pub. No.: US 2015/0315035 A1
(43) Pub. Date: Nov. 5, 2015

(54) ELECTROCHROMIC TUNGSTEN OXIDE FILMS FOR OPTICAL MODULATION AND METHODS OF MAKING THE SAME

(71) Applicants: Chi-Ping Li, Golden, CO (US); Colin A. Wolden, Denver, CO (US); Robert C. Tenent, Broomfield, CO (US); Chaiwat Engtrakul, Louisville, CO (US)

(72) Inventors: Chi-Ping Li, Golden, CO (US); Colin A. Wolden, Denver, CO (US); Robert C. Tenent, Broomfield, CO (US); Chaiwat Engtrakul, Louisville, CO (US)

(21) Appl. No.: 14/700,287

(22) Filed: Apr. 30, 2015

Related U.S. Application Data
(60) Provisional application No. 61/986,279, filed on Apr. 30, 2014.

(51) Int. Cl. C01G 41/02; B05D 1/02; B05D 3/00

(52) U.S. Cl. CPC C01G 41/02; B05D 3/007; B05D 1/02; C01P 2006/60

(57) ABSTRACT

The present invention relates to a tungsten oxide film and a method of making the film. The tungsten oxide film has greater than about 85% optical modulation across the visible spectrum. Furthermore, the film may be applied to a substrate that is not heated.

### CROSS REFERENCE TO RELATED APPLICATIONS

This application claims priority and the benefit under 35 U.S.C. §119(e) to U.S. Provisional Patent Application Ser. No. 61/986,279 filed Apr. 30, 2014, which is incorporated herein in its entirety by reference.

### GOVERNMENT LICENSE RIGHTS

This invention was made with government support under grant number DMR-0820518 awarded by the National Science Foundation and Contract No. DE-AC36-08GO28308 between the United States Department of Energy and the Alliance for Sustainable Energy, LLC, the Manager and Operator of the National Renewable Energy Laboratory. The Government has certain rights in the invention.

### FIELD OF THE INVENTION

The present invention relates an electrochromic film and the method of making the film. The film may be used for optical modulation.

### BACKGROUND OF THE INVENTION

The U.S. Department of Energy has estimated that the use of smart windows could reduce peak electric loads in buildings by 20-30%, but cost and unsatisfactory performance are two issues that limit wider adoption of this technology. Smart glass, also referred to as switchable, dimmable, or dynamic glass or glazing, varies the light transmittance and thermal properties of windows depending on changing ambient conditions and the needs of users and occupants. This class of high-performance glazing products offers significant energy efficiency, aesthetic, and user comfort and wellbeing benefits as compared to conventional “static” glazing. As benefits this industry, building and automotive design trends are showing a greater use of smart glass. Concurrently, changes in building codes and increased adoption of green building standards point to design challenges in managing heat gain and glare from increased glazing area ratios. Smart glass addresses these various market drivers.

Starting from a low base, smart glass for use in architectural and transportation facades, windows, and privacy screens is forecast to become a nearly $700 million sector of the flat glass market by 2020. The market will be dominated by architectural applications, mirroring overall market figures for flat glass globally, which are heavily skewed toward the buildings sector. Significant new production capacity entering the market in the near term will help drive down production costs and reduce the substantial price premium between static and dynamic glass, contributing to increased market share.

Tungsten Oxide (WO₃) is a transition metal oxide which is well-known for its non-stoichiometric properties that enable its use in numerous applications including electrochromics, photocatalysis, and sensor technology. Among these applications is electrochromic windows for both aesthetics and energy efficiency, which are the most highly developed applications with commercial products entering the market. The buildings sector consumes more energy than transportation or industry, accounting for 40% of energy expenditures in the US. Windows are responsible for a significant fraction, strongly influencing the cooling, heating and lighting requirements. Smart windows employing electrochromics have the potential to significantly reduce this energy footprint by controlling solar heat gain and lighting through modulation of their optical characteristics (i.e. transmittance, reflectance).

Tungsten oxide is the leading cathodic electrochromic material due to its excellent optical properties and reversibility in response to an applied voltage. There have been significant progress in the forty years since Deb's pioneering studies (S. K. Deb, Philosophical Magazine, 1973, 27, 801). Current applications for electrochromatic materials are mostly limited to niche markets such as dimmable rear view mirrors and the windows of Boeing's Dreamliner. Further improvements in both performance and cost reduction are required to enable widespread deployment of this technology. For example, a minor complaint about the Dreamliner is that the windows do not get dark enough. However, cost remains the main driver that must be addressed, particularly for energy efficient window applications.

Numerous techniques have been developed for the synthesis of WO₃ thin films. Physical vapor deposition techniques such as sputtering and thermal evaporation have been used extensively, but a drawback of these deposition techniques is the requirement for high vacuum chambers. In addition, these techniques typically produce dense films, and it can be challenging to efficiently introduce nanostructure or porosity.

Sol-gel chemistries combined with sacrificial templating agents can be used to create mesoporous structures that promote fast and efficient ion intercalation. Originally pioneered for silica, these strategies have been developed for numerous metal oxides as well as other materials through functionalization of silica. Application of these techniques to mesoporous WO₃ have demonstrated remarkably improved electrochromic properties.

Critical performance metrics for electrochromic materials include optical modulation, coloration efficiency, switching speed, and durability. The optical modulation (ΔT) is the difference in transmission between the bleached and colored states. The highest value reported to date for tungsten oxide is ΔT=85%, which in both cases was achieved in films deposited using sol gel chemistry. Coloration efficiency (CE) is based on the transmission change normalized by the amount of charge insertion as described by Equation (1):

$$CE = \frac{ln ( \frac{{T}_{bleach}}{{T}_{colored}} )}{Q \text{/} A} \qquad ( 1 )$$

where Q is the amount of charge inserted and A is the area of the sample. Leading films report coloration efficiencies on the order of 50 cm²/C, and the highest reported to date of CE=64 cm²/C was obtained using a proton containing electrolyte. There is no established standard for quantifying switching speed, but the most common metric employed is the time required to obtain 90% of full optical modulation, and time scales on the order of 10 s are commonly reported for nanostructured WO₃ films for small samples (˜1 cm²). These values are not suitable for comparison with the performance in an actual window. In addition, the switching speed will be different for samples that are not measured with a solid state electrolyte (which will impede switching speed in a fully integrated material). Crystallinity is a key metric impacting durability. Nanocrystalline WO₃ films have displayed better coloration efficiency and cycling stability than either amorphous WO₃ or bulk crystal WO₃ films. Mesoporous, crystalline WO₃ films provide an ideal morphology that imparts durability along with high surface specific area for efficient ion intercalation.

Sol-gel approaches have produced high performance material, but the techniques employed to produce these results such as dip coating, spin coating, or evaporation induced self assembly are generally quite slow and not amenable to large scale, in line manufacturing. The present invention addresses these and other issues.

### SUMMARY OF THE INVENTION

Electrochromic WO₃ films are generally produced by ultrasonic spray deposition techniques using templated sol-gel chemistry. By optimizing the sol (solution) composition mesoporous films are produced whose transparency in the visible may be modulated from about 0 to 100% during electrochemical cycling. The films display fast switching kinetics, producing an about 75% change in absolute transmission in about 3 seconds and about 27 second during coloration and bleaching, respectively. Optimum electrochromic performance can be achieved by controlling the sol concentration and/or the application thickness in this robust process. The excellent performance is attributed to the nanocrystalline nature of the films, which provides high specific surface area (>about 100 m²/g) for efficient lithium ion intercalation.

Smart windows are solar control devices that can electronically regulate the flow of sunlight and heat. The present invention includes a series of thin films deposited onto a glass substrate, one on top of the other, to form a functional electrochromic stack. The outermost layers can be transparent conductors, which can be used to apply a voltage to the active layers sandwiched between them. The active layers include an electrochromic (EC) layer, an ion conductor (IC) layer, and a counter electrode layer (CE). The EC layer is responsible for the majority of optical modulation, and the material of the EC layer is tungsten oxide that is commonly employed in commercial devices, including architectural product devices.

The present invention describes a unique chemistry and fabrication approach that produces mesoporous tungsten oxide films capable of modulating optical transmission up to the theoretical limit of about 100% in the visible regime (>about 550 nm). The novel process is based on adopting established sol-gel chemistry to ultrasonic spray deposition (USD). USD is performed under ambient conditions as opposed to high vacuum sputtering (the standard commercial process), and as such is more amenable to in-line, high volume, low cost manufacturing. Though the focus of the present invention is electrochromics, mesoporous thin films are employed in a number of applications including membranes, batteries, and filters, and solar cells. The process described here is expected to be highly amenable to a wide range of mesoporous materials.

This process is distinct from conventional spray pyrolysis, where a heated substrate is used to drive the chemistry involved in film formation. Advantages of USD include low capital requirements and materials utilization that approaches about 100%. Moreover, the use of benign solvents such as water and alcohol enables processing under ambient conditions. USD has also been used to produce high performance nickel oxide, a leading counter electrode in the electrochromic stack, and as such one could envision employing USD for in-line production of complete devices.

The baseline process employed in the present invention is nearly identical to conventional sol-gel processing, with the exception that the sol is deposited by USD onto an unheated substrate instead of by spin coating. The sol is comprised of WCl₆ and an organic templating agent (P123) dissolved in ethanol. Films are then placed into a humidified environment to facilitate hydrolysis and gelation. Lastly, a high temperature calcination step is used to remove the organic template, complete the oxidation process, and induce crystallinity. The annealing step is critical, and that best results were obtained with rapid annealing in which the substrates directly on a hot plate maintained at 350° C. Under these conditions films displayed about 75% optical modulation, in some embodiments up to about 100% optical modulation, a coloration efficiency of about 50 cm²/C, and very fast switching times (<10 s).

Performance of the coating correlates with the nanostructure and the specific surface area of the nanocrystalline films. The shape and size of the mesoporous networks may be directed through the control of parameters such as sol composition. The volume fraction of the block copolymer can be used for the rationale control of nanostructure, and optimization of this critical parameter has been used successfully to control porosity and increase specific surface area in a number of material systems.

### BRIEF DESCRIPTION OF THE DRAWINGS

FIG. 1A illustrates scanning electron microscope (SEM) images cross sections (left) and plan view (right) images of mesoporous films deposited at 1C×6P;

FIG. 1B illustrates SEM images cross sections (left) and plan view (right) images of mesoporous films deposited at 1.5C×4P;

FIG. 1C illustrates SEM images cross sections (left) and plan view (right) images of mesoporous films deposited at 2C×3P;

FIG. 2A illustrates a transmission electron microscope (TEM) images (left) and selected area diffraction patterns (right) obtained from WO₃ films deposited using sols at 1C levels;

FIG. 2B illustrates a transmission electron microscope (TEM) images (left) and selected area diffraction patterns (right) obtained from WO₃ films deposited using sols at 1.5C levels;

FIG. 2C illustrates a transmission electron microscope (TEM) images (left) and selected area diffraction patterns (right) obtained from WO₃ films deposited using sols at 2C levels;

FIG. 3A illustrates Raman spectra obtained from WO₃ films deposited using sols at 1C, 1.5C, and 2C levels;

FIG. 3B illustrates wide angle XRD patterns obtained from WO₃ films deposited using sols at 1C, 1.5C, and 2C levels;

FIG. 4A illustrates a comparison of N₂ physisorption isotherms obtained from mesoporous WO₃ produced in accordance with the invention (1.5 C) and a previous study;

FIG. 4B illustrates the pore size distributions obtained for samples at 1C, 1.5C, 2C, and a previous study;

FIG. 5 illustrates the cyclic voltammograms (left axis) and the optical transmission (670 nm) recorded in registry (right axis) during the second (solid) and 20^{th} (dashed) cycle from a film deposited using 1.5C×4P;

FIG. 6 illustrates the coloration efficiency (solid symbols) and optical modulation (open symbols) obtained from films deposited as a function of the product of sol concentration (C) and number of passes (P) for sol concentration levels of 1C (squares), 1.5C (circles), 2C (triangles);

FIG. 7 illustrates a dynamic optical response to applied step potentials from films deposited using 1C×4, 5, 6 passes, 1.5C×1, 2, 3 passes and 2C×1, 2, 3 passes;

FIG. 8 illustrates comparison of times required to obtain about 75% optical modulation (absolute basis) during bleaching and coloration for films deposited under optimal conditions for the three concentration levels;

FIG. 9 illustrates bleached and colored transmission spectra obtained from a film deposited using 1.5C×4 passes with insets photographs of samples illuminated by a flashlight;

FIG. 10A illustrates N₂ physisorption isotherms obtained from mesoporous WO₃ films produced at 1C×6P;

FIG. 10B illustrates N₂ physisorption isotherms obtained from mesoporous WO₃ films produced at 2C×3P;

FIG. 11A illustrates cyclic voltammograms (left axis) and the optical transmission (670 nm) recorded in registry (right axis) during the second (solid) and 20^{th} (dashed) cycle from film deposited at 1C×6P;

FIG. 11B illustrates cyclic voltammograms (left axis) and the optical transmission (670 nm) recorded in registry (right axis) during the second (solid) and 20^{th} (dashed) cycle from film deposited at 2C×3P;

FIG. 12A illustrates bleached and colored transmission spectra obtained from films deposited at 1C×6P; and

FIG. 12B illustrates bleached and colored transmission spectra obtained from films deposited at 2C×3P.

### DETAILED DESCRIPTION

The present invention relates an electrochromic film and the method of making the film. The film may be used for optical modulation.

### DEFINITION

Sol-gel: is shorthand for solution gelation chemistry, which generally means a liquid solution that evolves into a gel like state through stirring and/or drying.

An aspect of the invention is a method to produce an electrochromic film. The method includes providing sol, wherein the sol comprises WCl₆ and an organic templating agent dissolved in an alcohol. The baseline solution was prepared by dissolving 1 g of Triblock polymer Pluronic P123 (poly(ethylene oxide)-b-poly(propylene oxide)-b-poly(ethylene), EO₂₀PO₇₀EO₂₀) into 10 ml of anhydrous ethanol. The sol was completed by adding about 0.595 g of WCl₆ (≧99.9%) followed by 12 hours of stirring. The sol is deposited by ultrasonic spray deposition onto an unheated substrate, which does not require spin coating. The films are placed into an approximately 100% humidified environment to facilitate hydrolysis and gelation. The films are then subjected to a high temperature calcination step to remove the organic template, complete the oxidation process, and induce crystallinity. The resulting WO₃ films may greater than about 85% optical modulation across the visible spectrum. In some embodiments, the films may display about 100% optical modulation across the visible spectrum through optimization of the sol composition.

The mass ratio (WCl₆:Organic templating agent) may be between about 0.1 and about 5. In some embodiments, the ratio may be between about 0.2 to about 2, in some embodiments between about 0.3 to about 1. In some embodiments, the reagent ratio may be about 0.595.

The organic templating agent may be any suitable organic templating agent, including but not limited to Pluronic P123 (poly(ethylene oxide)-b-poly(propylene oxide)-b-poly(ethylene), EO₂₀PO₇₀EO₂₀), or another agent that includes a triblock copolymer. The alcohol may be any suitable alcohol, including but not limited to ethanol, methanol, isopropanol, propanol, combinations thereof, or the like.

The reagent ratio will impact of the total concentration in alcohol. The concentration of the WCl₆ in the alcohol may be between about 0.5 mM to about 5 mM, in some embodiments about 1.5 mM to about 3 mM. In some embodiments, the concentration may be about 1.5 mM, about 2.25 mM, or about 3 mM. Concentrated sols at 1.5, 2.25 and 3 mM, are denoted in the description as 1C, 1.5C and 2C, respectively. The sol concentration significantly impacts the morphology and nanostructure of the mesoporous films as well as their electrochromic performance.

The calcining step may occur at a temperature between about 300° C. and about 400° C. In some embodiments, the calcining step may occur at a temperature of about 300° C., about 310° C., about 320° C., about 330° C., about 340° C., about 350° C., about 360° C., about 370° C., about 380° C., about 390° C., or about 400° C. In some embodiments, the substrate with the sol is calcined for between about 30 minutes to about 20 hours, about 4 hours to about 15 hours, or about 8 hours to about 10 hours.

The sol may be applied to the substrate by ultrasonic spraying. The ultrasonic spray nozzle may be operated at a flow rate between about 0.05 mL/min to about 2 mL/min, in some embodiments about 0.25 mL/min. In some embodiments, the flow rate may be between about 0.5 mL/min to about 1 mL/min. In some embodiments, the flow rate may be about 0.05 mL/min, about 0.8 mL/min, about 0.9 mL/min, about 1.0 mL/min, about 1.1 mL/min, about 1.2 mL/min, about 1.3 mL/min, about 1.4 mL/min, about 1.5 mL/min, about 1.6 mL/min, about 1.7 mL/min, about 1.8 mL/min, about 1.9 mL/min, or about 2 mL/min.

The frequency of the ultrasonic spray nozzle during application may be between about 10 kHz to about 1000 kHz, in some embodiments about 120 kHz. In some embodiments, the frequency may be about 10 kHz, about 20 kHz, about 30 kHz, about 40 kHz, about 50 kHz, about 100 kHz, about 200 kHz, about 300 kHz, about 400 kHz, about 500 kHz, about 600 kHz, about 700 kHz, about 800 kHz, about 900 kHz, or about 1000 kHz.

The sol may be entrained in a gas, wherein the gas is selected from the group consisting of nitrogen, argon, helium, combinations thereof, or similar inert gases. In some embodiments, the gas may be nitrogen. The flow rate of the gas provided to the nozzle may be between about 1 to about 10 slm. In some embodiments, the flow rate may be about 1 slm, about 2 slm, about 3 slm, about 4 slm, about 5 slm, about 6 slm, about 7 slm, about 8 slm, about 9 slm, or about 10 slm.

The substrate may be any suitable material, including but not limited to, a glass material, a membrane, and a filter, and combinations thereof. The substrate may be positioned between about 1 cm to about 20 cm from the tip of the ultrasonic spray nozzle. In some embodiments, the distance between the substrate and the tip of the ultrasonic spray nozzle may be about 1 cm, about 5 cm, about 10 cm, about 15 cm, or about 20 cm. The substrate may be cleaned prior to applying the sol using any suitable method. In some embodiments, the substrates may be cleaned by soaking in alcohol, wiped dry, blown dry with a gas then placed into an oxygen plasma prior to use.

The parameters discussed above are for one spray orifice. One skilled in the art would understand that multiple spray orifices may be used by scaling the amounts and flow rates of the materials. Another aspect of the present invention is a method to apply a film to a substrate. The method includes preparing a sol, wherein the sol includes tungsten hexachloride and an organic templating agent dissolved in an alcohol to produce a film precursor. The film precursor is applied to at least one substrate to form a coated substrate. The coated substrate is exposed to a humidified environment to produce film gelation. The film gelation is calcined to produce a film. The resulting WO₃ films display greater than about 85% optical modulation across the visible spectrum through optimization of the sol composition.

The mass ratio (WCl6:Organic templating agent) may be between about 0.1 and about 5. In some embodiments, the ratio may be between about 0.2 to about 2, between about 0.4 and about 1, in some embodiments between about 0.3 to about 1. In some embodiments, the ratio may be about 0.597.

The alcohol may be any suitable alcohol, including but not limited to ethanol, methanol, isopropanol, propanol, combinations thereof or the like.

The reagent ratio will impact of the total concentration in alcohol. The concentration of the WCl₆ in the alcohol may be between about 0.5 mM to about 5 mM, in some embodiments be between 1.5 mM to about 3 mM. In some embodiments, the concentration may be about 1.5 mM, about 2.25 mM, or about 3 mM. Concentrated sols at 1.5, 2.25 and 3 mM, are denoted in the description as 1C, 1.5C and 2C, respectively. The sol concentration significantly impacts the morphology and nanostructure of the mesoporous films as well as their electrochromic performance.

The calcining step may occur at a temperature between about 300° C. and about 400° C. In some embodiments, the calcining step may occur at a temperature of about 300° C., about 310° C., about 320° C., about 330° C., about 340° C., about 350° C., about 360° C., about 370° C., about 380° C., about 390° C., or about 400° C. Calcining occurs for between about 10 minutes to about 24 hours. In some embodiments, the substrate with the sol is calcined for between about 30 minutes to about 20 hours, about 4 hours to about 15 hours, or about 8 hours to about 10 hours.

The templating agent may be a triblock copolymer. In some embodiments, the triblock copolymer may include poly(ethylene oxide)-b-poly(propylene oxide)-b-poly(ethylene), EO₂₀PO₇₀EO₂₀. In some embodiments, the triblock copolymer is Pluronic P123.

The sol may be applied to the substrate by ultrasonic spraying. The flow rate of ultrasonic spray nozzle may be between about 0.5 mL/min to about 2 mL/min, in some embodiments about 0.25 mL/min. In some embodiments, the flow rate may be about 0.05 mL/min, about 0.8 mL/min, about 0.9 mL/min, about 1.0 mL/min, about 1.1 mL/min, about 1.2 mL/min, about 1.3 mL/min, about 1.4 mL/min, about 1.5 mL/min, about 1.6 mL/min, about 1.7 mL/min, about 1.8 mL/min, about 1.9 mL/min, or about 2 mL/min.

The frequency of the ultrasonic spray nozzle during application may be between about 10 kHz to about 1000 kHz, in some embodiments about 120 kHz. In some embodiments, the frequency may be about 10 kHz, about 20 kHz, about 30 kHz, about 40 kHz, about 50 kHz, about 100 kHz, about 200 kHz, about 300 kHz, about 400 kHz, about 500 kHz, about 600 kHz, about 700 kHz, about 800 kHz, about 900 kHz, or about 1000 kHz.

The sol may be entrained in a gas, wherein the gas is selected from the group consisting of nitrogen, argon, helium, combinations thereof, or similar materials. In some embodiments, the gas may be nitrogen. The flow rate of the gas provided to the nozzle may be between about 1 to about 10 slm. In some embodiments, the flow rate may be about 1 slm, about 2 slm, about 3 slm, about 4 slm, about 5 slm, about 6 slm, about 7 slm, about 8 slm, about 9 slm, or about 10 slm.

The substrate may be any suitable material, including but not limited to, a glass material, a membrane, and a filter, and combinations thereof. The substrate may be positioned between about 1 cm to about 20 cm from the tip of the ultrasonic spray nozzle. In some embodiments, the distance between the substrate and the tip of the ultrasonic spray nozzle may be about 1 cm, about 5 cm, about 10 cm, about 15 cm, or about 20 cm. The substrate may be cleaned prior to applying the sol using any suitable method. In some embodiments, the substrates may be cleaned by soaking in alcohol, wiped dry, blown dry with a gas then placed into an oxygen plasma prior to use.

Another aspect of the invention is a film. The film comprises tungsten oxide, where the tungsten oxide has greater than about 85% optical modulation across a visible spectrum. In some embodiments, the optical modulation across the visible spectrum may be greater than about 85%, greater than about 90%, greater than about 95%, greater than about 97%, greater than about 98%, greater than about 99% or about 100%. In some embodiments, the optical transmission may be about 85%, about 90%, about 95%, about 95%, about 97%, about 98%, about 99% or about 100%. The film may be used for coating a substrate to reduce the transmission of light.

The film thickness may be controlled as it is a product of the sol concentration and the number of passes (P) through a deposition zone. In some embodiments, the film thickness may be between about 200 nm and about 2000 nm. In some embodiments, the film thickness may be about 200 nm, about 300 nm, about 400 nm, about 500 nm, about 600 nm, about 700 nm, about 800 nm, about 900 nm, about 1000 nm, about 1100 nm, about 1200 nm, about 1300 nm, about 1400 nm, about 1500 nm, about 1600 nm, about 1700 nm, about 1800 nm, about 1900 nm, or about 200 nm.

The structure of the deposited film may be mesoporous. The particle size of the individual nanocrysallites in the film may be between about 3 nm to about 15 nm. In some embodiments, may be about 3 nm, about 4 nm, about 5 nm, about 6 nm, about 7 nm, about 8 nm, about 9 nm, about 10 nm, about 11 nm, about 12 nm, about 13 nm, about 14 nm, or about 15 nm. The average pore size in the mesoporous film may be between 2 nm and 12 nm. In some embodiments, the average pore size may be about 2 nm, about 3 nm, about 4 nm, about 5 nm, about 6 nm, about 7 nm, about 8 nm, about 9 nm, about 10 nm, about 11 nm, or about 12 nm.

The optical transmission of the film may be greater than 85% across the visible spectrum (about 550 nm to about 950 nm). In some embodiments, the optical modulation across the visible spectrum may be greater than about 85%, greater than about 90%, greater than about 95%, greater than about 97%, greater than about 98%, greater than about 99% or about 100%. In some embodiments, the optical transmission may be about 85%, about 90%, about 95%, about 95%, about 97%, about 98%, about 99% or about 100%.

The film may be in a colored state or the film may be in a bleached state. The film may be colored in about 3 seconds by application of appropriate voltage in an Li+-containing electrolyte solution. The film may be bleached in about 20-60 seconds by application of appropriate voltage in an Li+-containing electrolyte solution. In some embodiments, the film may be transparent. In some embodiments, the film may be less than about 90% transparent.

### Examples

### Preparation of Sol Solution

Triblock polymer Pluronic P123 (poly(ethylene oxide)-b-poly(propylene oxide)-b-poly(ethylene), EO₂₀PO₇₀EO₂₀), anhydrous ethanol and tungsten hexachloride (WCl₆) were all purchased from Sigma-Aldrich and used without further purification. An inert glove box was used for reagent storage and sol preparation, due to the moisture sensitivity of these components. Sol solution preparation began by separately dissolving about 1 grams, about 1.5 grams and about 2 grams of the triblock copolymer P123 in 10 ml anhydrous ethanol (≧99.5%) for 1C, 1.5C and 2C concentration levels, respectively. The sol was completed by adding about 0.595 grams, about 0.8925 grams, and about 1.19 g of WCl₆ (≧99.9%) to the 1C, 1.5C and 2C triblock copolymer/ethanol solution and followed by 12 hours of stirring to produced sols that were then used for ultrasonic spray deposition.

### Preparation of Gel Films

The stable sols was transferred to a syringe and delivered to the ultrasonic spray nozzle at a flow rate of 0.25 ml/min using Fluid Metering Inc. VMP TRI Pulseless “Smoothflow” pump. The ultrasonic spray system was obtained from Sono-Tek Corporation and consisted of a model 8700-120 spray head that operated at a frequency of 120 kHz. The spray nozzle had a 0.230 in. diameter conical tip and 0.015 in. diameter orifice that was fitted with the impact system for gas-driven spray delivery. The atomized mist was entrained in a stream of nitrogen whose flowrate was fixed at 6.9 slm using an electronic mass flow controller (Omega FMA 1818). This aerosol was directed onto fluorinated tin oxide (FTO) coated glass (TEC-15, Pilkington) positioned 5 cm below the nozzle under ambient conditions. Other suitable materials include transparent conducting oxide (TCO) and TCO like materials, including ZnO:Al. Before deposition, all substrates were cleaned with an isopropanol-soaked clean-room wipe, blown dry with nitrogen, and then placed in an oxygen plasma (800 mtorr, 155 W) for 5 minutes. Samples were mounted on a computer controlled stage which rastered them through the deposition zone for the desired number of spray passes, producing uniform, iridescent blue films. Samples were then transferred into a chamber saturated with water vapor for hydrolysis.

### Preparation of Tungsten Oxide Thin Films

The final step is calcination, where samples are heated in air to remove residual solvent and the polymer template while completing the oxidation and crystallization of the WO₃. Samples were placed directly onto a hot plate set at maintained at about 350° C. After 1 hour on the hot plate the samples were removed and allowed to naturally cool down to room temperature.

### Film Synthesis and Characterization

The nanoscale morphology was examined by transmission electron microscopy (TEM, Philips CM200). Selected area diffraction (SAD) patterns were carried out by using 200 kV electrons. Samples for transmission electron microscopy (TEM) and selected area diffraction (SAD) were produced by suspending scraped tungsten oxide powder in ethanol using sonication and placing a drop on a TEM grid and allowing the solvent to evaporate. FESEM characterization of the films was performed on a JEOL JSM-7000F microscope operating at 2 keV. The crystallinity of final tungsten oxide films were assessed by X-ray diffraction (XRD) using CuKα radiation over a range of 20=20-65° using 0.05° steps. Raman spectroscopy was performed using the about 488 nm line of a 15 mW argon ion laser. N₂ physisorption was performed using a Micrometrics ASAP 2020 after samples were degassed at 250° C. under vacuum for 4 h.

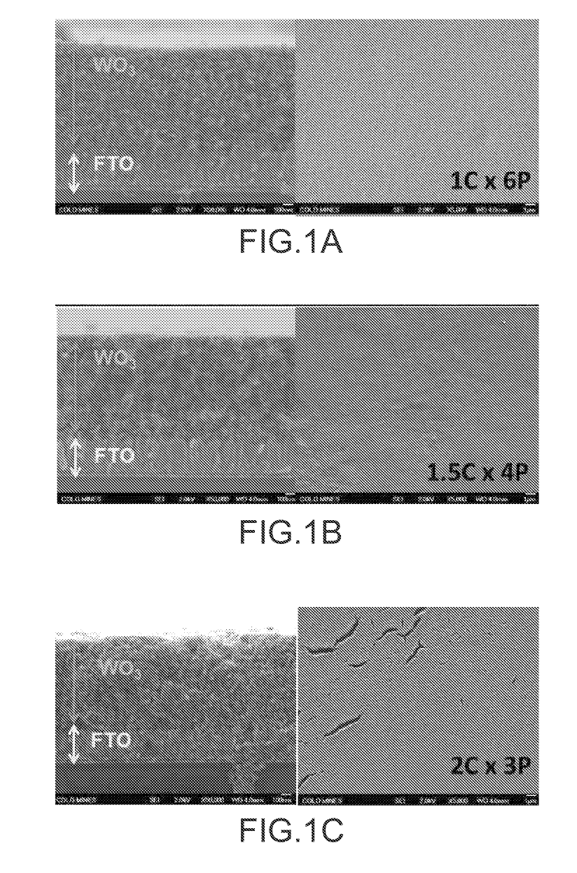

The film thickness may be proportional to the sol concentration (C) multiplied by the number of passes (P) made through the deposition zone. FIG. 1 illustrates a cross-section view and a plan view scanning electron micrographs (SEM) of films deposited for C×P=6 using the three different concentration levels (1C, 1.5C and 2C). From the cross section images all three films have very similar thickness (˜1 μm), and the mesoporous structure is clearly evident. The amount of material deposited per pass was approximately 167, 250 and 333 nm, respectively, for the three concentration levels. The films deposited at the lowest concentration (1C) were very smooth and uniform across the entire substrates, which were 6×6 inch FTO-coated glass plates.

At the intermediate concentration (1.5C), the surface of the films becomes somewhat wavy, and at 2C there are surface cracks are visible in some regions. These macroscopic changes in morphology are attributed to the viscosity of the sol, which increases linearly with sol concentration from about 3.4 cP at 1C to about 7 cP at 2C. At higher viscosity the size of the droplets produced by the ultrasonic nebulizer increases, as does their distribution. The 2C concentration was the highest used with the present equipment, as clogging was observed at higher concentrations.

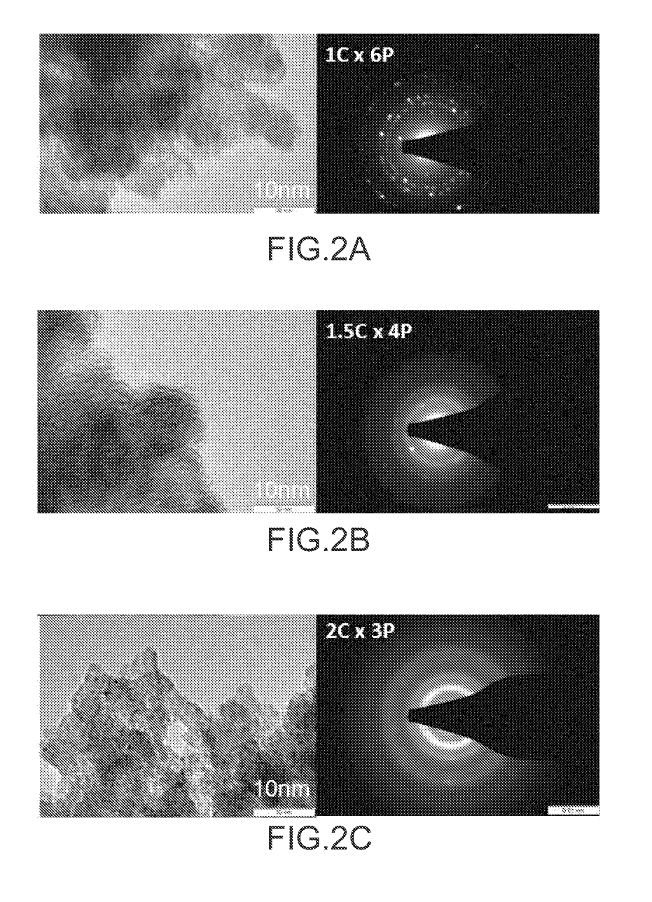

FIG. 2 illustrates transmission electron microscopy (TEM) images and selected area diffraction (SAD) patterns obtained from the material deposited at the three difference concentration levels (1C, 1.5C and 2C). The nanocrystalline nature of the material is confirmed by the TEM images, as lattice fringes are readily observed at all three conditions. As the sol concentration increases, the primary particle size decreases from 5-6 nm at 1C to 3-4 nm at 2C. This evolution in size is confirmed by the SAD patterns. All the samples have rings indicative of a nanocrystalline morphology. The ring spacings are consistent with the monoclinic γ-phase, which is the most commonly observed form of tungsten oxide. At the baseline concentration, the particles are sufficiently large that distinct spots dominate the diffraction patterns. As the concentration increased, the intensity of these spots is attenuated, and at 2C only rings are observed in the SAD patterns.

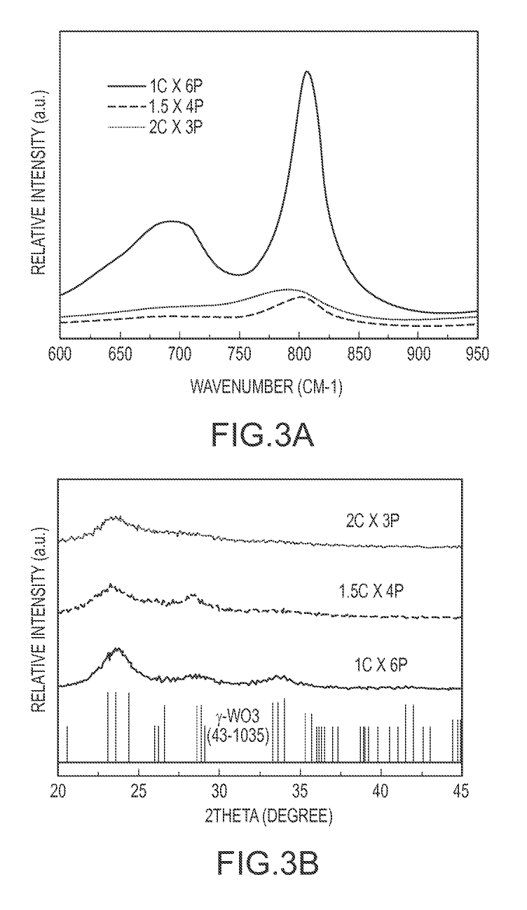

FIG. 3A illustrates the Raman spectra and FIG. 3B illustrates wide angle X-ray diffraction (XRD) patterns observed as a function of concentration, further confirming the size dependence. At the baseline concentration, the Raman spectrum (FIG. 3A) illustrates broad bands centered at about 805 and about 690 cm⁻¹, which are attributed to the v(O-W-O) stretching mode of WO₃. These signals are significantly attenuated at higher concentrations. As the particle size decreases, the bonding becomes dominated by surface terminations instead of bulk, breaking the symmetry and long range order required by Raman. A similar trend is observed in XRD (FIG. 3B), where the most intense diffraction signals for monoclinic WO₃ are the three lines appearing between 2θ=about 22-25°. This is the only region that shows significant diffraction in the sol-gel samples. The peaks broaden with increasing sol concentration, consistent with decreasing particle size observed in TEM imaging and further confirming the nanocrystalline nature of the samples.

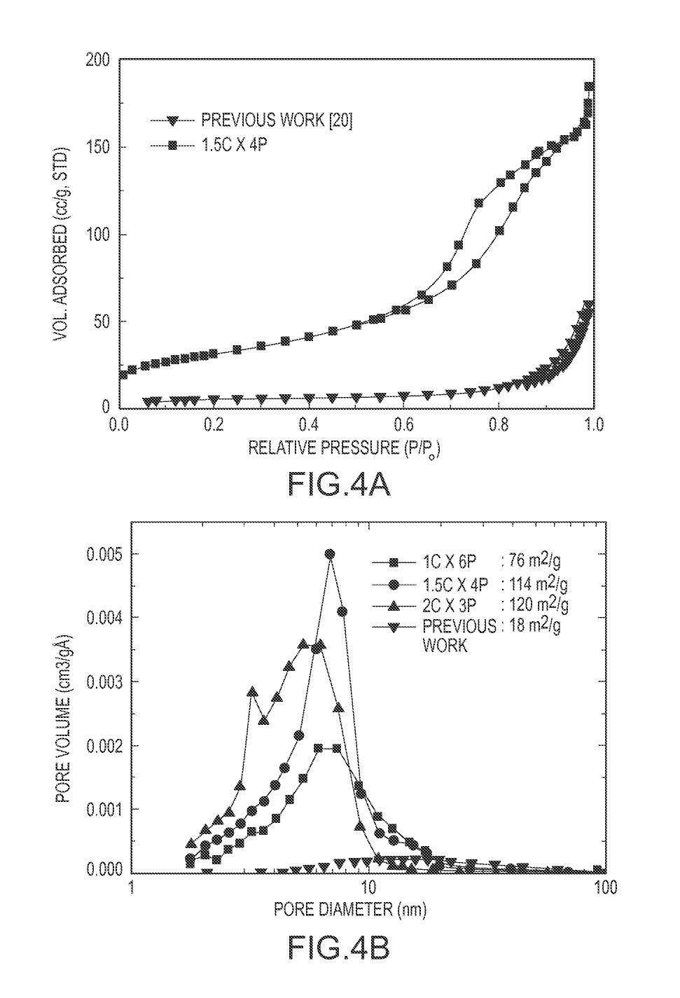

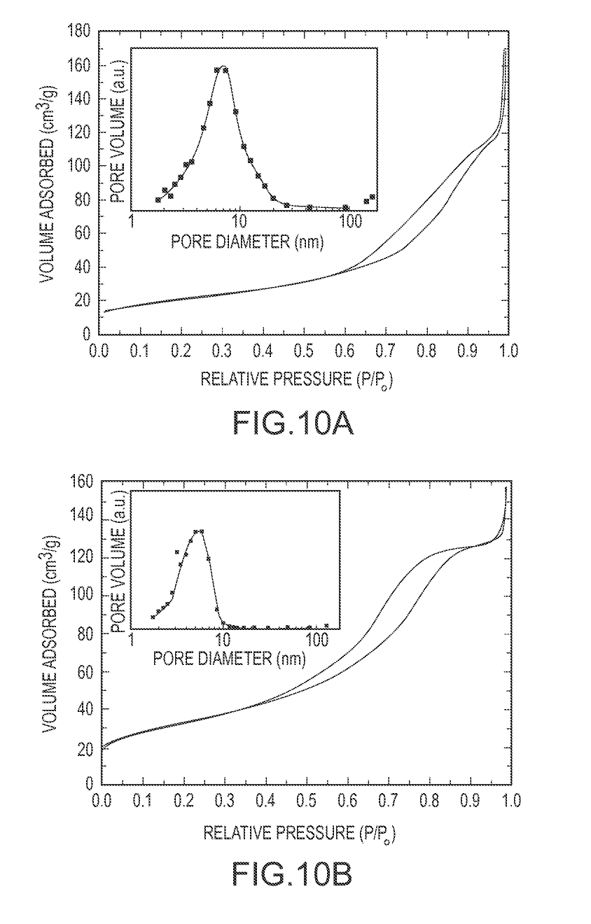

The structural changes described above are manifested through significant improvements in the specific surface area of the mesoporous films. FIG. 4A compares the N₂ physisorption isotherms obtained from material produced using the methods of the present invention at 1.5C with the best material produced in using the method discussed in an earlier study (C.-P. Li et al., Electochem. Comm. 2012, 25, 62) (“previous study”). Isotherms obtained from the 1C and 2C concentration levels are very similar and illustrated in FIG. 10. The shapes of the isotherms from this work correspond to type IV of the BET classification, characteristic of mesoporous materials. The dramatic increase in both total volume and the level of splitting between the adsorption/desorption branches illustrate the profound differences between the two materials. FIG. 4B compares the pore size distributions extracted from the physisorption curves. The material produced using methods discussed in the previous study displayed a very broad pore size distribution ranging from about 5-50 nm, a mean pore size of about 18 nm, and a specific surface area of 18 m²/g. The mesoporous material produced using the methods of the present invention is characterized by much smaller pores with a tighter distribution and significantly enhanced total surface area. At the baseline concentration (1 C), the pore volume dramatically increased, the mean pore size was reduced to 7 nm, and the distribution significantly tightened. The resulting specific surface area increased to about 75.8 m²/g. At the concentration level of 1.5 C the mean pore size remained unchanged, but the distribution narrowed and the specific surface area increased to about 114 m²/g. At the highest concentration (2C), the mean pore size decreased to 5 nm as the density of small pores (<5 nm) was enhanced, and the specific surface area was further increased to about 120 m²/g. These physisorption results are perfectly consistent with the trends observed in TEM, SAD, Raman and XRD. The specific areas achieved in this work are comparable to the highest values ever reported for mesoporous tungsten oxide.

### Electrochemical Characterization

Electrochromic performance was evaluated by cycling films in an electrolyte composed of about 1 M LiClO₄ dissolved in propylene carbonate in a test cell housed in an Ar-purged glovebox. Cyclic voltammetry and potential cycling measurements were made using a BioLogic VMP3 multichannel potentiostat. Cyclic voltammetry (CV) was performed using an about 20 mV/s scan rate between about 2 and 4 V vs. Li/Li⁺. Switching kinetics was measured using chronoamperometric cycling between about 1.7 and 4.2 V vs. Li/Li⁺, and the switching speed is defined as the time required to achieve 75% of the full optical change. A diode laser (about 670 nm) coupled to a detector (Thor Labs, Inc. DET100A) was used to collect optical transmission in direct registry during cycling. For analysis of the full transmission spectra the laser and detector were replace by a broadband halogen light source and an Ocean Optics USB 4000 fiber optic spectrometer, respectively. In both cases contribution of a clean FTO substrate was background subtracted, so that the reported optical response reflects only contributions from the WO₃ film. In addition, both still images and videos of the transmission change were acquired by illuminating the cell with a standard incandescent flashlight and recording the transmission with a fiber-optic based camera (General Tools Model DCS050).

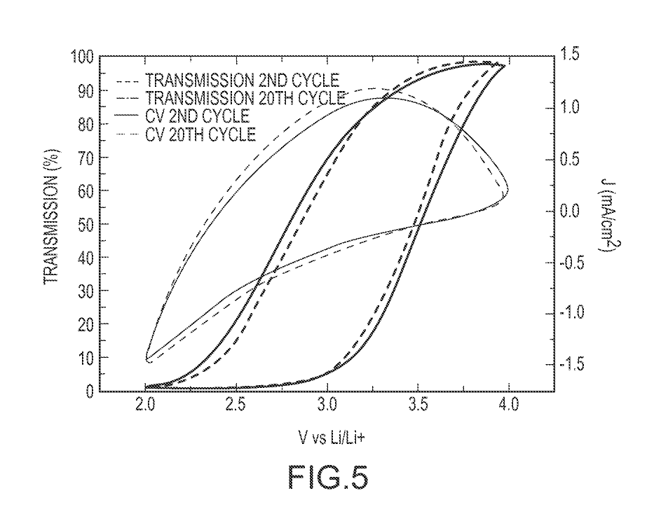

FIG. 5 illustrates cyclic voltammograms (CVs) and the associated optical response of a film deposited at 1.5C×4 P during its 2^{nd} and 20^{th} cycle. The second cycle is illustrated since a small level of irreversible intercalation is always observed in the first CV cycle. In subsequent cycles, lithium intercalation is completely reversible. The CV exhibits current densities in excess of about 1 mA/cm², reflecting the high density of lithium intercalation. The most striking feature in FIG. 5 is the optical transmission, as the modulation approaches the theoretical maximum of 100%. This is a dramatic increased over the previous benchmark of 85%, and it is a standard that cannot be improved upon. The CV and transmission curves evolve between the 2^{nd} and 20^{th} cycle, but what is remarkable is that the electrochromic performance actually improves. Typically during extended cycling the charge capacity falls, the CVs contract, and the optical modulation declines. However for products of the present invention, the CV expands as more charge is inserted, and as such the voltage range required to effect 100% modulation is reduced. While not wanting to be bound by theory, it is believed that the movement of ions into and out of the material further increases its disorder, increasing the charge capacity.

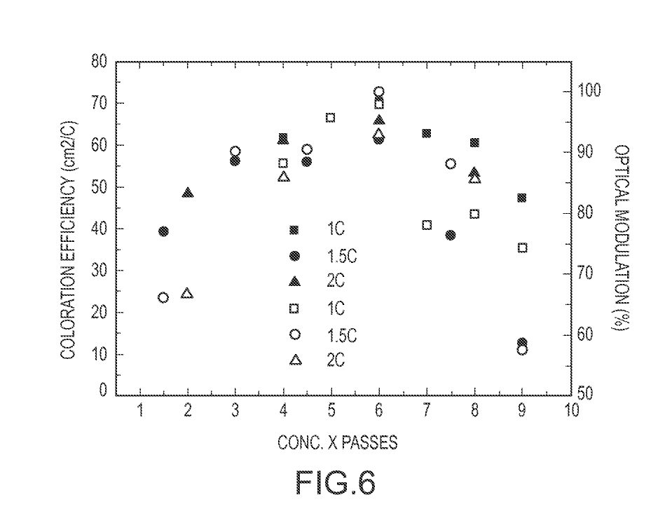

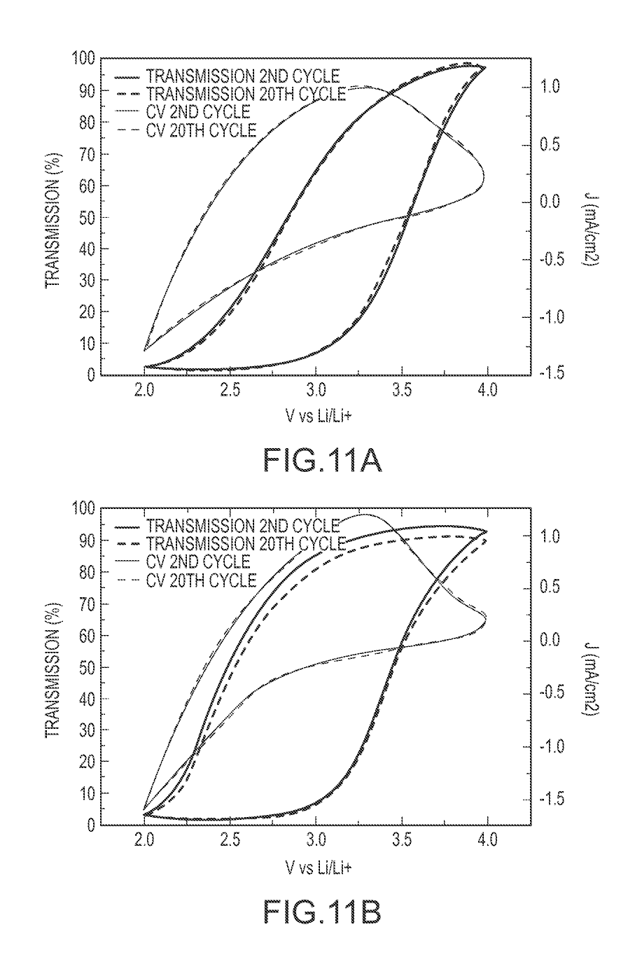

In the cyclic voltammetry analysis, the electrochromic performance was found to primarily be a function of the film thickness, and nominally independent of the sol concentration. Representative plots of CVs and optical transmission from the 1C and 2C levels are illustrated in FIG. 11, while FIG. 6 summarizes the data in terms of coloration efficiency and optical modulation. The film thickness was found to be proportional to product of the sol concentration and the number of passes, and this is the independent variable plotted in FIG. 6. During cyclic voltammetry, it was found that electrochromic performance was optimized at C×P=6, which corresponds to the ˜1 micron thick films illustrated in FIG. 1. At this condition, both ΔT and CE reach optimum values of about 100% and about 70 cm²/C, respectively, with the latter value also setting a new standard for tungsten oxide. For films deposited at C×P<6, the optical modulation declines because the films are too thin and the transmission cannot reach 0% in the colored state. Likewise for C×P>6 the films are too thick, and cannot reach 100% transmission in the bleached state. FIG. 6 illustrates data obtained at all three concentration levels, and though there is some scatter in the data, the basic trends with thickness are quite consistent.

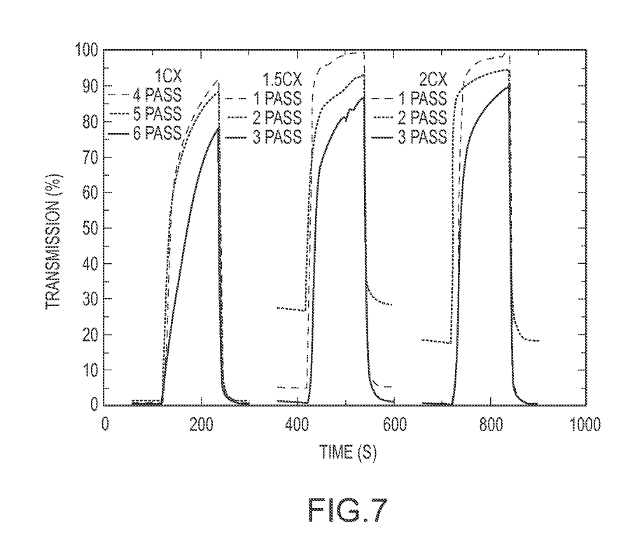

The electrochromic performance during cyclic voltammetry was nominally identical at the three concentration levels (1C, 1.5C, and 2C). The lithium ion intercalation rate during CV is relatively slow, and as such the coloration efficiency reflected the charge capacity of the material. To assess the dynamics of switching, the films were exposed to alternating step potentials with a period of about 120 seconds. FIG. 7 illustrates the response of selected films at each of the three concentration levels. In contrast to the CV results, the dynamic response reflects the differences in nanostructure discussed above. Note that the degree of voltage modulation (about 1.7-4.2 V vs. Li/Li⁺) used in these experiments was greater than in the CV studies (about 2-4 V vs. Li/Li), which is why 100% optical modulation is obtained in films that are thinner than C×P=6 value that was found to be optimal in the CV (FIG. 6). In all cases, the rate of coloration is fast, and it is the bleaching step that limits switching speed. In these step potential experiments, the transmission changes are controlled by the rate of Li⁺ extraction from WO₃ and transport out of the film. As such, the impact of nanostructure is evident and the optimal thickness is reduced relative to CV. At the 1C level, the optimum number of passes was about 4-5. In the colored state these films were completely opaque, but could only reach about 90% transparency during the about 120 seconds bleaching step. At the intermediate concentration, 1.5C×2 P was observed to produce the optimal thickness, obtaining 96% optical modulation. At the highest concentration films made using 2C×2P achieved 100% optical modulation. Films deposited at 2C×1P were insufficiently opaque under coloration, while 2C×3P films were too thick and limited by the response time.

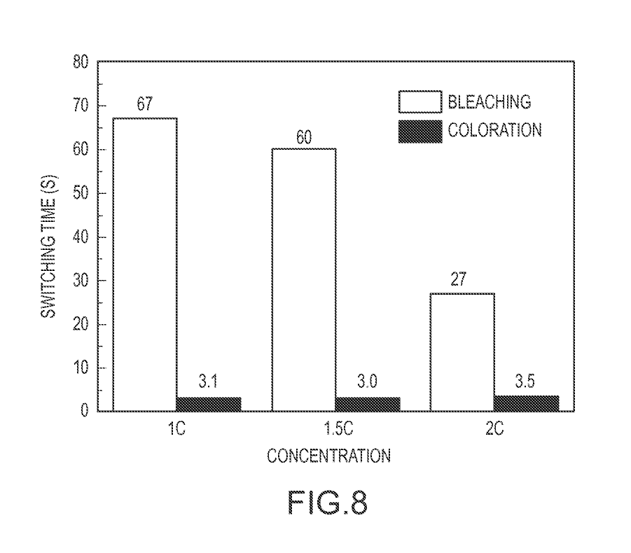

Switching speed was quantified by the time required to modulate the absolute transmission by about 75%. FIG. 8 illustrates the time required for both bleaching and coloration for optimized films at each concentration level. For coloration the switching times of three different concentration levels are very fast, around just 3 seconds. However, the bleaching time is sensitive to nanostructure, decreases with sol concentration from about 67 s at 1C to about 27 s at 2C. Both the switching times and the maximum level of optical modulation (about 90%, about 96%, about 100%) achieved correlates exceptionally well with the specific surface area (about 76 m²/g, about 114 m²/g, about 120 m²/g) obtained from the three concentration levels (1C, 1.5C, 2C, respectively), reflecting the importance of this parameter on the rate of Li⁺ extraction. An important point, at least for this application, is that such periodicity is unnecessary for top performance. The films described here are completely disordered, and specific surface area and pore size are the key metrics that control performance.

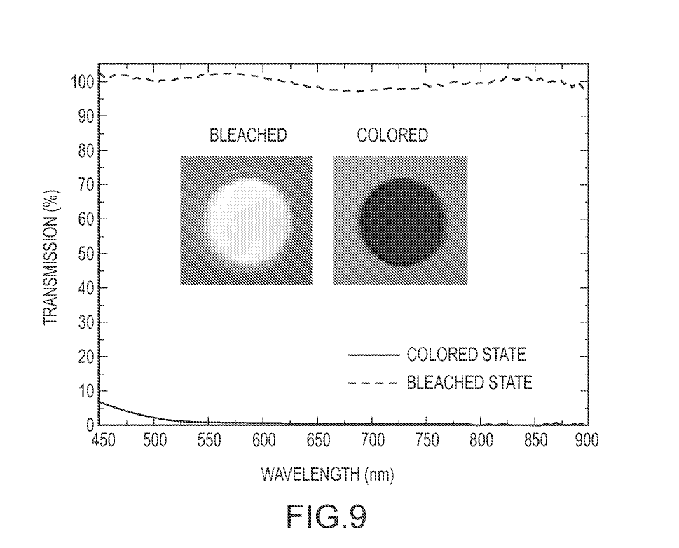

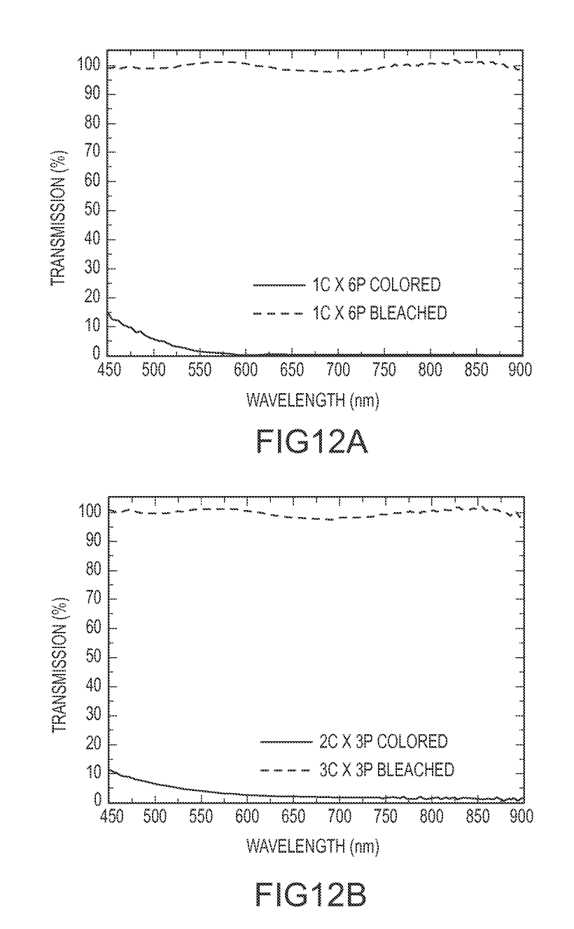

The optical response reported in FIGS. 5-7 was recorded by a laser operating at 670 nm. To assess the full spectral response the laser and photodiode were replaced by a broadband halogen source and a fiber-optic based spectrometer, respectively. About 100% optical modulation may be obtained for films at all concentration levels given appropriate thickness and applied voltage. FIG. 9 illustrates the transmission spectra obtained in the fully colored and bleached from a film deposited using 1.5C×4P. In the bleached state perfect transparency is obtained across the full spectral range, with any deviation associated with noise induced during background subtraction. Likewise the films are completely opaque at wavelengths >about 550 nm. As the wavelength is reduced a small amount of blue light is transmitted, but remains <about 8% at about 450 nm. Aesthetics are an important consideration in electrochromic applications, so the optical response was also quantified by illuminating one side of the testing cell with a standard incandescent flashlight and monitoring the transmission with a fiber optic-based camera on the other. Photographs from this experiment of the illuminated test cell in the colored and bleached states are provided as insets to FIG. 9. These agree well with the spectra, as white light is observed in the transparent state and dark blue in the opaque, reflecting the low wavelength transmission shown in the spectra. The photographs also provide a testament to the uniformity, as the there is no variation in appearance across the approximately 1 cm diameter site glass. The performance was for films deposited at the other concentration levels displayed nominally identical spectra, examples of which are illustrated in FIGS. 12A and B. The flashlight/camera arrangement was also used to create movies of the dynamic switching studies. Again the data in FIG. 7 reflected the response at λ=about 670 nm, though it is also possible to analyze over the full visible spectrum.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiment described hereinabove is further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

1. A method of applying a film to a substrate, comprising:
preparing a sol of a sol-gel process, wherein the sol comprises tungsten hexachloride and an organic templating agent dissolved in an alcohol to produce a film precursor;
applying the film precursor to an unheated substrate to prepare a coated substrate;
exposing the coated substrate to a humidified environment to produce film gelation;
calcining the film gelation to produce a film.

2. The method of claim 1, wherein the calcining occurs at a temperature between about 300° C. and about 400° C.

3. The method of claim 1, wherein the calcining occurs for between about 0.1 and about 1 hour.

4. The method of claim 1, wherein the templating agent is a triblock copolymer.

5. The method of claim 4, wherein the triblock copolymer is poly(ethylene oxide)-b-poly(propylene oxide)-b-poly(ethylene), EO₂₀PO₇₀EO₂₀.

6. The method of claim 1, wherein the ratio of the tungsten hexachloride to the organic templing agent is about 1:4.

7. The method of claim 1, wherein the ratio of the tungsten hexachloride to the organic templing agent is about 1:9.

8. The method of claim 1, wherein a ratio of the tungsten hexacloride to the alcohol is between about 1.5 mM and about 3.0 mM.

9. The method of claim 1, wherein the alcohol is selected from the group consisting of ethanol, methanol, isopropanol, propanol, and combinations thereof.

10. The method of claim 1, wherein the sol is applied to the substrate by an ultrasonic spraying.

11. The method of claim 10, wherein the ultrasonic spraying comprises entraining the sol in a gas.

12. The method of claim 11, wherein the gas is at least one of nitrogen, argon, helium, and combinations thereof.

13. The method of claim 1, wherein the substrate is at least one of a glass material, a membrane, and a filter.

14. A film for coating a substrate to reduce the flow of energy, comprising:
tungsten oxide, wherein the tungsten oxide comprises greater than about 85% optical modulation across a visible spectrum.

15. The film of claim 14, wherein the optical modulation is about 100%.

16. The film of claim 14, wherein the film is bleached or colored.

17. The film of claim 14, wherein the substrate is at least one of a glass material, a membrane, and a filter.

18. The film of claim 14, wherein the film is translucent.

19. The film of claim 14, wherein the particle size of a nanocrystallite in the film is between 5 to about 20 nm.

20. A method to apply a film to a substrate, comprising:
preparing a sol, wherein the sol comprises tungsten hexachloride and an organic templating agent dissolved in an alcohol to produce a film precursor;
applying the film precursor to an unheated substrate by ultrasonic spraying to prepare a coated substrate;
exposing the coated substrate to a humidified environment to produce film gelation; and
calcining the film gelation to produce a film, wherein the film is tungsten oxide, and wherein the film comprises greater than about 85% optical modulation across a visible spectrum, wherein the substrate is at least one of a glass material, a membrane, and a filter.
